(19) United States
(12) Patent Application Publication
(10) Pub. No.: US 2007/0249776 A1
(43) Pub. Date: Oct. 25, 2007

(54) BLACK-MATRIX BANK COMPOSITION AND METHOD FOR MANUFACTURING BLACK-MATRIX BANKS

(75) Inventor: WEI-YUAN CHEN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: ICF TECHNOLOGY CO., LTD., Hsinchu (TW)

(21) Appl. No.: 11/560,781

(22) Filed: Nov. 16, 2006

(30) Foreign Application Priority Data
Apr. 21, 2006 (TW) 95114386

(51) Int. Cl. C08K 3/04

(52) U.S. Cl. 524/495

(57) ABSTRACT

A material for black-matrix banks includes a colorant, a solvent, an initiator, an oligomer, a polymer, and an additive. The total amount of the colorant in the material ranges from about 0.1% to about 40% by weight. The total amount of the solvent in the material ranges from about 1% to about 95% by weight. The total amount of the initiator in the material ranges from about 0.01% to about 15% by weight. The total amount of the oligomer in the material ranges from about 0.1% to about 30% by weight. The total amount of the polymer in the material ranges from above 0% to about 30% by weight. The total amount of the additive in the material ranges from above 0% to about 10% by weight.

### BACKGROUND

1. Technical Field

The present invention relates generally to black-matrix banks compositions and method for manufacturing the black-matrix banks and, more particularly, to a cross-linking material for manufacturing black-matrix banks of color filters.

2. Discussion of Related Art

A color filter is one of the most important elements in a liquid crystal display device. The color filters are generally used in the liquid crystal display devices for converting white light transmitted therethrough into red (R) light, green (G) light and blue (B) light. The red light, the green light and the blue light are configured for liquid crystal display (LCD) devices that display color images.

Conventional, methods for manufacturing the color filters mostly include a pigment-dispersed method and an ink jet method.

The pigment-dispersed method is widely used as a manufacturing method for color filters. The pigment-dispersed method uses color pigment photoresists forming red, green and blue sub-pixels by means of a spin-exposure-development process. Specifically, red pigment photoresist, blue pigment photoresist and green pigment photoresist are sequentially applied to a glass substrate with a black matrix, exposed to the ultraviolet-light with the help of a photomask after drying, and developed to form red sub-pixels, green sub-pixels and blue sub-pixels color layers respectively. Since the process has to be repeated three times or more, these manufacturing devices are both expensive to use and time-consuming to operate.

The ink jet method is different from other conventional methods and is a method in which each of R, G, and B inks are sprayed onto a substrate from respective nozzles to form a color layer. When this method is employed, the required amount of ink can be applied onto a required place at a specific time. Accordingly, there is no waste of ink. Furthermore, since the sub-pixels of R, G, and B can be formed simultaneously, the printing process is shortened, and it is possible to markedly reduce cost.

Generally, banks are arranged on the substrate of the color filter to prevent the ink from flooding one sub-pixel, overflowing into adjacent sub-pixels and mixing with the ink therein. Correspondingly, the banks mentioned above can include single-layer banks (black matrix only), or multi-layer banks (black matrix and one or more top layer on the black matrix). The single-layer banks are called black-matrix banks here.

However, a contact angle of the conventional material of the black-matrix banks is so small that the affinity between the ink and the banks is increased. As a result, the ink is can easily climb over the black-matrix banks and overflow into the adjacent sub-pixels.

What is needed, therefore, is a black-matrix bank composition having a big contact angle and a method for manufacturing the black-matrix banks.

### SUMMARY

A black-matrix bank composition, includes a colorant, a solvent, an initiator, an oligomer, a polymer, and an additive. The total amount of the colorant in the material ranges from about 0.1% to about 40% by weight (wt). The total amount of the solvent in the material ranges from about 1% to about 95% by weight. The total amount of the initiator in the material ranges from about 0.01% to about 15% by weight. The total amount of the oligomer in the material ranges from about 0.1% to about 30% by weight. The total amount of the polymer in the material ranges from above 0% to about 30% by weight. The total amount of the additive in the material ranges from above 0% to about 10% by weight.

A manufacturing method of black-matrix banks in accordance with a preferred embodiment includes the steps of: providing a substrate; forming a photoresist layer on the substrate using the material mentioned above; and forming black-matrix banks on the substrate.

### DETAILED DESCRIPTION OF PREFERRED EMBODIMENTS

Reference will now be made to describe embodiments of the present invention.

The present black-matrix bank composition includes a colorant, a solvent, an initiator, an oligomer, a polymer, and an additive. The total amount of the colorant in the material ranges from about 0.1% to about 40% by weight (wt), and is more preferably from about 3% to about 30% by weight. The total amount of the solvent in the material ranges from about 1% to about 95% by weight, and is more preferably from about 25% to about 85% by weight. The total amount of the initiator in the material ranges from about 0.01% to about 15% by weight, and is more preferably from about 0.1% to about 8% by weight. The total amount of the oligomer in the material ranges from about 0.1% to about 30% by weight, and is more preferably from about 3% to about 20% by weight. The total amount of the polymer in the material ranges from above 0% to about 30% by weight, and is more preferably from about 0.1% to about 15% by weight. The total amount of the additive in the material ranges from above 0% to about 10% by weight, and is more preferably from about 0.01% to about 5% by weight.

The colorant is comprised of a material selected from the group consisting of dyestuff, pigment and a combination thereof. Preferably, the colorant is a black carbon material.

The solvent is an organic solvent, and the organic solvent mostly includes ester, ether, alcohol ether, ketone, alcohol, polyol derivant , nitrogen-containing solvent and so on. More specifically, the preferred solvent is selected from the group consisting of methoxy butanol, isopropyl alcohol, butanol, benzyl alcohol, butyl ether, ethylene glycol propyl ether, ethylene glycol butyl ether, ethylene glycol hexyl ether, ethylene glycol benzyl ether, ethylene glycol butyl ether acetate, diethylene glycol dimethyl ether, diethylene glycol monoethyl ether, diethylene glycol monobutyl ether, diethylene glycol hexyl ether, triethylene glycol monomethyl ether, triethylene glycol monoethyl ether, triethylene glycol monobutyl ether, propylene glycol monomethyl ether, propylene glycol methyl ether acetate, propylene glycol monobutyl ether, tripropylene glycol monobutyl ether, propylene glycol benzyl ether, ethyl acetate, butyl acetate, benzoic acid ethyl ester, ethyl 3-ethoxy propionate, acetone, methyl ethyl ketone, methyl n-amyl ketone, methyl isobutyl ketone, diisobutylketone (DIBK), isophorone, cyclohexanone(CYC), 2-pyrrolidene ketone, and N-methyl-2-pyrrolidene ketone.

The initiator used can be photo initiator. The photo initiator includes but is not limited to 4,4-bis(dimethylamino)benzophenone, 4,4′-bis(diethylamino)benzophenone, 2-(4-methoxyphenyl)-4,6-bis(trichloromethyl)-1,3,5-triazine, tris(trichloromethyl)-1,3,5-triazine, IRGACURE® 819, IRGACURE® 369, IRGACURE® 2959, IRGACURE® 379, IRGACURE® 184, IRGACURE® 784, IRGACURE® 250, IRGACURE® 907, IRGACURE® 651, IRGACURE® OXE01, IRGACURE® OXE02, IRGACURE® 500, IRGACURE® 1800, IRGACURE® 1000, IRGACURE® 1700, DAROCURE® BP, DAROCURE® 1173CGI242, DAROCURE® 1173CGI-552, products of Ciba Specialty Chemicals, JP, Chivacure® TPO, Chivacure® TPO-L, Chivacure® 200, products of Double Bond Chemical IND., CO., LTD, TAIWAN, KAYACURE DETX-S, KAYACURE CTX, KAYACURE BMS, KAYACURE BP-100, Chivacure® 107, Chivacure® 184, Chivacure® 284, IRGACURE° OXE02, KAYACURE DETX-S, KAYACURE CTX, KAYACURE BMS, or KAYACURE BP-100.

The oligomer includes at least one substance chosen from the group consisting of unsaturated acrylate oligomer and its derivative, unsaturated epoxy acrylate oligomer and its derivative, unsaturated urethane oligomer and its derivative, unsaturated ester oligomer and its derivative. A preferable choice is a material selected from the group consisting of epoxy acrylate oligomer, ester acrylate oligomer, polybutadiene acyrlate oligomer, acrylic oligomer, diacrylate oligomer, triacrylate oligomer, metallic acrylate oligomer and urethane oligomer.

The oligomer as described above can comprise one or more functional groups by modification. The modified functional groups are selected from the group consisting of hydroxyl group(—OH), hydrogencyanato(—HCN), amino group(—NH), isocyanato(—NCO), carboxy(—COOH), —SH, epoxy group, vinyl group, aromatic ring, amide group, ester, urethane, siloxane, sulfide, anhydride, urea, carbonate, phosphate ester and sulfone.

The polymer is polymerized or copolymerized by at least one kind of organic monomer. The organic monomers are selected from the group consisting of acrylic acid, methacrylic acid, acrylate, methacrylate, and any derivate monomers thereof.

The additive is used to change the property of the material so as to match with the production requirements, thereby obtaining a product having desirable properties. The additive is comprised of a material selected from the group consisting of surfactant, dispersant, antifoaming agent, defoamer, wetting agent, and any combination thereof.

The surfactant is mostly used for controlling surface tension of the material. The surfactant includes non-ionic surfactant, or anionic surfactant. The surfactant is comprised of a material selected from the group consisting of siloxane containing organic compounds, fluorine-containing organic compounds, polyoxyethylene-containing compounds.

Dispersants are mostly used for enhancing dispersion stability of the colorant. The preferred material of the dispersant is selected from the group consisting of acrylate type or modified acrylate type organic compound, and urethane type or modified urethane type organic compounds. Dispersant agents currently in use include Solsperse 5000, Solsperse 1700, Solsperse 20000, Solsperse 24000, Solsperse 32500 etc.

The antifoaming agent and defoamer are used for restraining and slating air bubbles generated in the material. The preferred material of the antifoaming and the defoamer is siloxane-containing organic compounds.

The material further includes a monomer. The total amount of the monomer in the material ranges from above 0 to about 30% by weight, and is more preferably from about 3% to about 20% by weight.

A manufacturing method of black-matrix banks in accordance with a preferred embodiment includes the steps of:
(1) providing a substrate;
(2) applying a photoresist layer on the substrate using the material mentioned above; and
(3) exposing and developing the photoresist layer to form black-matrix banks on the substrate.

In step (2), the photoresist layer can be formed on the substrate using a method chosen from the group consisting of spin coating, slit coating, and slit and spin coating.

In step (3), the photoresist layer is exposed via a photo mask and developed to form patterned black-matrix banks. The photoresist layer may be solidified through a solidifying device.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A black-matrix bank composition, comprising:
a colorant in an amount by weight of about 0.1% to about 40%;
a solvent in an amount by weight of about 1% to about 95%;
an initiator in an amount by weight of about 0.01% to about 15%;
an oligomer in an amount by weight of about 0.1% to about 30%;
a polymer in an amount by weight of above 0% to about 30%;
an additive in an amount by weight of above 0% to about 10%.

2. The black-matrix bank composition as claimed in claim 1, wherein the amount by weight of the colorant is in the range from about 3% to about 30%.

3. The black-matrix bank composition as claimed in claim 1, wherein the amount by weight of the solvent is in the range from about 25% to about 85%.

4. The black-matrix bank composition as claimed in claim 1, wherein the amount by weight of the initiator is in the range from about 0.1% to 8%.

5. The black-matrix bank composition as claimed in claim 1, wherein the amount by weight of the oligomer is in the range from about 3% to 20%.

6. The black-matrix bank composition as claimed in claim 1, wherein the amount by weight of the polymer is in the range from about 0.1% to 15%.

7. The black-matrix bank composition as claimed in claim 1, wherein the amount by weight of the additive is in the range from about 0.01% to 5%.

8. The black-matrix bank composition as claimed in claim 1, wherein a material of the colorant is selected from the group consisting of dyestuff, pigment, and a combination thereof.

9. The black-matrix bank composition as claimed in claim 1, wherein a material of the colorant is black carbon.

10. The black-matrix bank composition as claimed in claim 1, wherein the solvent is an organic solvent.

11. The black-matrix bank composition as claimed in claim 10, wherein the organic solvent is selected from the group consisting of ester, ether, alcohol ether, ketone, alcohol, polyol derivative and nitrogen-containing solvent.

12. The black-matrix bank composition as claimed in claim 10, wherein the organic solvent is selected from the group consisting of methoxybutanol, isopropyl alcohol, butanol, benzyl alcohol, butyl ether, THF, ethylene glycol propyl ether, ethylene glycol butyl ether, ethylene glycol benzyl ether, ethylene glycol butyl ether acetate, diethylene glycol dimethyl ether, diethylene glycol monoethyl ether, diethylene glycol monobutyl ether, diethylene glycol hexyl ether, triethylene glycol monomethyl ether, triethylene glycol monoethyl ether, triethylene glycol monobutyl ether, propylene glycol monomethyl ether, propylene glycol methyl ether acetate, propylene glycol monobutyl ether, tripropylene glycol monobutyl ether, propylene glycol benzyl ether, ethyl acetate, butyl acetate, benzoic acid ethyl ester, ethyl 3-ethoxy propionate, acetone, methyl ethyl ketone, methyl n-amyl ketone, methyl isobutyl ketone, diisobutylketone, isophorone, cyclohexanone, 2-pyrrolidene ketone, N-methyl-2-pyrrolidene ketone, and dimethyl sulfoxide.

13. The black-matrix bank composition as claimed in claim 1, wherein the initiator is a photo initiator.

14. The black-matrix bank composition as claimed in claim 13, wherein the photo initiator is selected from the group consisting of 4,4-Bis(dimethylamino) Benzophenone, 4,4′-Bis(Diethylamino)Benzophenone, 2-(4-Methoxyphenyl)-4,6-Bis(Trichloromethyl)-1,3,5-Triazine, and Tris(trichloromethyl)-1,3,5-Triazine.

15. The black-matrix bank composition as claimed in claim 13, wherein the photo initiator is selected from the group consisting of IRGACURE® 819, IRGACURE® 369, IRGACURE® 2959, IRGACURE® 379, IRGACURE® 184, IRGACURE® 784, IRGACURE® 250, IRGACURE® 907, IRGACURE® 651, IRGACURE® OXE01, IRGACURE® OXE02, IRGACURE® 500, IRGACURE® 1800, IRGACURE® 1000, IRGACURE® 1700, DAROCURE® BP, DAROCURE® 1173CGI242, DAROCURE® 1173CGI-552, Chivacure® TPO, Chivacure® TPO-L, Chivacure® 200, KAYACURE DETX-S, KAYACURE CTX, KAYACURE BMS, KAYACURE BP-100, Chivacure® 107, Chivacure® 184, Chivacure® 284, IRGACURE® OXE02, KAYACURE DETX-S, KAYACURE CTX, KAYACURE BMS, and KAYACURE BP-100.

16. The black-matrix bank composition as claimed in claim 1, wherein the oligomer comprises organic unsaturated epoxy acrylate oligomer and its derivative.

17. The black-matrix bank composition as claimed in claim 1, wherein the oligomer comprises unsaturated urethane oligomer and its derivative.

18. The black-matrix bank composition as claimed in claim 1, wherein the oligomer comprises unsaturated ester oligomer and its derivative.

19. The black-matrix bank composition as claimed in claim 1, wherein the oligomer is comprised of a material selected from the group consisting of epoxy acrylate oligomer, ester acrylate oligomer, polybutadiene acyrlate oligomer, acrylic oligomer, diacrylate oligomer, triacrylate oligomer, metallic acrylate oligomer and urethane oligomer.

20. The black-matrix bank composition as claimed in claim 1, wherein the oligomer comprises one or more functional groups selected from the group consisting of —OH, —HCN, —NH, —NCO, —COOH, —SH, epoxy group, vinyl group, aromatic ring, amide group, ester, urethane, siloxane, sulfide, anhydride, urea, carbonate, phosphate ester and sulfone.

21. The black-matrix bank composition as claimed in claim 1, wherein a monomer for the polymer is selected from the group consisting of acrylic acid, methacrylic acid, acrylate, methacrylate, and any derivate monomers thereof.

22. The black-matrix bank composition as claimed in claim 1, wherein the additive comprises surfactant.

23. The black-matrix bank composition as claimed in claim 1, wherein the additive comprises antifoaming agent or defoamer.

24. The black-matrix bank composition as claimed in claim 1, wherein the additive comprises dispersant or wetting agent.

25. The black-matrix bank composition as claimed in claim 22, wherein the surfactant comprises non-ionic surfactant.

26. The black-matrix bank composition as claimed in claim 22, wherein the surfactant comprises anionic surfactant.

27. The black-matrix bank composition as claimed in claim 22, wherein the surfactant comprises siloxane containing organic compounds.

28. The black-matrix bank composition as claimed in claim 22, wherein the surfactant comprises fluorine-containing organic compounds.

29. The black-matrix bank composition as claimed in claim 22, wherein the surfactant comprises polyoxyethylene-containing compounds.

30. The black-matrix bank composition as claimed in claim 1, further comprising a monomer.

31. The black-matrix bank composition as claimed in claim 30, wherein an amount by weight of the monomer is in the range from above 0 to about 30%.

32. The black-matrix bank composition as claimed in claim 31, wherein the amount by weight of the monomer is in the range from about 3% to about 20%.

33. Amanufacturing method for black-matrix banks, comprising the steps of:
providing a substrate;
applying a photoresist layer on the substrate, the photoresist layer comprising the black-matrix bank composition as claimed in claim 1; and
exposing and developing the photoresist layer to form black-matrix banks on the substrate.

34. The method as claimed in claim 33, wherein the photoresist layer is formed on the substrate using a method selected from the group consisting of a spin coating method, a slit coating method, and a slit and spin coating method.

35. The method as claimed in claim 33, further comprises a step of solidifying the photoresist layer using a solidifying device.
